(19) United States
(12) Patent Application Publication
(10) Pub. No.: US 2026/0105887 A1
(43) Pub. Date: Apr. 16, 2026

(54) LIGHT EMITTING DEVICE, DISPLAY DEVICE, PHOTOELECTRIC CONVERSION DEVICE, ELECTRONIC APPARATUS, ILLUMINATION DEVICE, AND MOVING BODY

(71) Applicant: CANON KABUSHIKI KAISHA, Tokyo (JP)

(72) Inventors: SHINTARO MAEKAWA, Kanagawa (JP); MIZUKI NAGASAKI, Kanagawa (JP)

(21) Appl. No.: 19/382,543

(22) Filed: Nov. 7, 2025

Related U.S. Application Data
(63) Continuation of application No. PCT/JP2024/014545, filed on Apr. 10, 2024.

(30) Foreign Application Priority Data
May 25, 2023 (JP) 2023-086432

(51) Int. Cl. G09G 3/3225

(52) U.S. Cl. CPC G09G 3/3225; G09G 2310/08; G09G 2320/0233

(57) ABSTRACT

A light emitting device including a pixel array including pixels arranged so as to form rows, a write controller to supply a write control signal to a selected row in order to write an image signal, and a light emission controller to supply a light emission control signal to a selected row. The rows include a row including a holding circuit and a gate circuit, the holding circuit memorizes that the write control signal is supplied to the row including the holding circuit and the gate circuit, and in a case where the light emission control signal is supplied to the gate circuit and the holding circuit memorizes that the write control signal is supplied, the gate circuit outputs the light emission control signal to a pixel arranged in a row including the holding circuit and the gate circuit.

### CROSS-REFERENCE TO RELATED APPLICATIONS

This application is a Continuation of International Patent Application No. PCT/JP2024/014545, filed Apr. 10, 2024, which claims the benefit of Japanese Patent Application No. 2023-086432, filed May 25, 2023, both of which are hereby incorporated by reference herein in their entirety.

### BACKGROUND

### Field of the Technology

The present disclosure relates to a light emitting device, a display device, a photoelectric conversion device, an electronic apparatus, an illumination device, and a moving body.

### Description of the Related Art

In light emitting devices, there is known an “image retention” phenomenon in which, when the same character or image is displayed at the same position for a long time, the light emission characteristic of the region where the same thing is kept displayed changes, so that a luminance difference occurs between the region and the surroundings. PTL 1 describes that the position of a display region to display a character or image is shifted in order to suppress image retention.

When the display region is shifted, if the pixel row changed from the non-display region to the display region emits light before an image signal is written, display quality can be deteriorated.

PTL 1: Japanese Patent Laid-Open No. 2020-076863

### SUMMARY

It is an object of the present disclosure to provide a technique advantageous in improving display quality.

According to some embodiments, a light emitting device comprising: a pixel array including a plurality of pixels arranged so as to form a plurality of rows; a write control circuit configured to supply a write control signal to a selected row in order to write an image signal in a pixel arranged in a selected row among the plurality of rows; and a light emission control circuit configured to supply a light emission control signal to a selected row among the plurality of rows, wherein the plurality of rows includes a row including a holding circuit and a gate circuit, the holding circuit memorizes that the write control signal is supplied to the row including the holding circuit and the gate circuit, and in a case where the light emission control signal is supplied to the gate circuit and the holding circuit memorizes that the write control signal is supplied, the gate circuit outputs the light emission control signal to a pixel arranged in a row including the holding circuit and the gate circuit, is provided.

Features of the present disclosure will become apparent from the following description of embodiments with reference to the attached drawings.

### BRIEF DESCRIPTION OF THE DRAWINGS

The accompanying drawings, which are incorporated in and constitute a part of the specification, illustrate embodiments of the disclosure and, together with the description, serve to explain principles of the disclosure.

FIG. 1 is a view showing an example of the arrangement of a light emitting device according to an embodiment.

FIG. 2 is a circuit diagram showing an example of the arrangement of a pixel arranged in the light emitting device shown in FIG. 1.

FIG. 3A is a view for explaining the display position shift in the light emitting device shown in FIG. 1.

FIG. 3B is a view for explaining the display position shift in the light emitting device shown in FIG. 1.

FIG. 3C is a view for explaining the display position shift in the light emitting device shown in FIG. 1.

FIG. 4 is a view showing an example of the arrangement of a vertical scanning circuit of the light emitting device shown in FIG. 1.

FIG. 5 is a timing chart showing an example of the operation of the light emitting device shown in FIG. 1.

FIG. 6 is a view showing an example of the arrangement of the vertical scanning circuit of the light emitting device shown in FIG. 1.

FIG. 7A is a timing chart showing an example of the operation of the light emitting device shown in FIG. 1.

FIG. 7B is a timing chart showing an example of the operation of the light emitting device shown in FIG. 1.

FIG. 8 is a view showing an example of the arrangement of the vertical scanning circuit of the light emitting device shown in FIG. 1.

FIG. 9 is a timing chart showing an example of the operation of the light emitting device shown in FIG. 1.

FIG. 10A is a sectional view showing an example of the arrangement of the pixel of the light emitting device shown in FIG. 1.

FIG. 10B is a sectional view showing an example of the arrangement of the pixel of the light emitting device shown in FIG. 1.

FIG. 11A is a view showing an example of an image forming device using the light emitting device according to the embodiment.

FIG. 11B is a view showing the example of the image forming device using the light emitting device according to the embodiment.

FIG. 11C is a view showing the example of the image forming device using the light emitting device according to the embodiment.

FIG. 12 is a view showing an example of a display device using the light emitting device according to the embodiment.

FIG. 13 is a view showing an example of a photoelectric conversion device using the light emitting device according to the embodiment.

FIG. 14 is a view showing an example of an electronic apparatus using the light emitting device according to the embodiment.

FIG. 15A is a view showing an example of a display device using the light emitting device according to the embodiment.

FIG. 15B is a view showing an example of a display device using the light emitting device according to the embodiment.

FIG. 16 is a view showing an example of an illumination device using the light emitting device according to the embodiment.

FIG. 17 is a view showing an example of a moving body using the light emitting device according to the embodiment.

FIG. 18A is a view showing an example of a wearable device using the light emitting device according to the embodiment.

FIG. 18B is a view showing an example of a wearable device using the light emitting device according to the embodiment.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

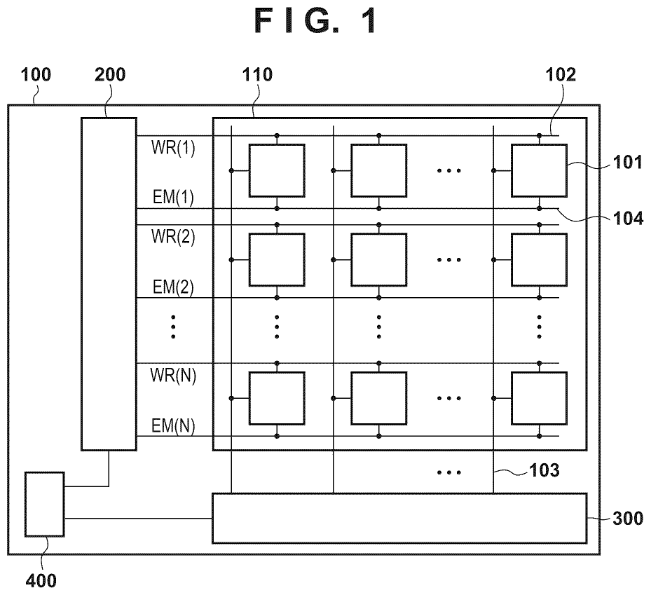

With reference to FIGS. 1 to 9, a light emitting device according to an embodiment of the present disclosure will be described. The following embodiments are merely examples of the present disclosure and not intended to limit the scope of the disclosure according to the appended claims. FIG. 1 is a schematic view showing an example of the arrangement of a light emitting device 100 according to this embodiment.

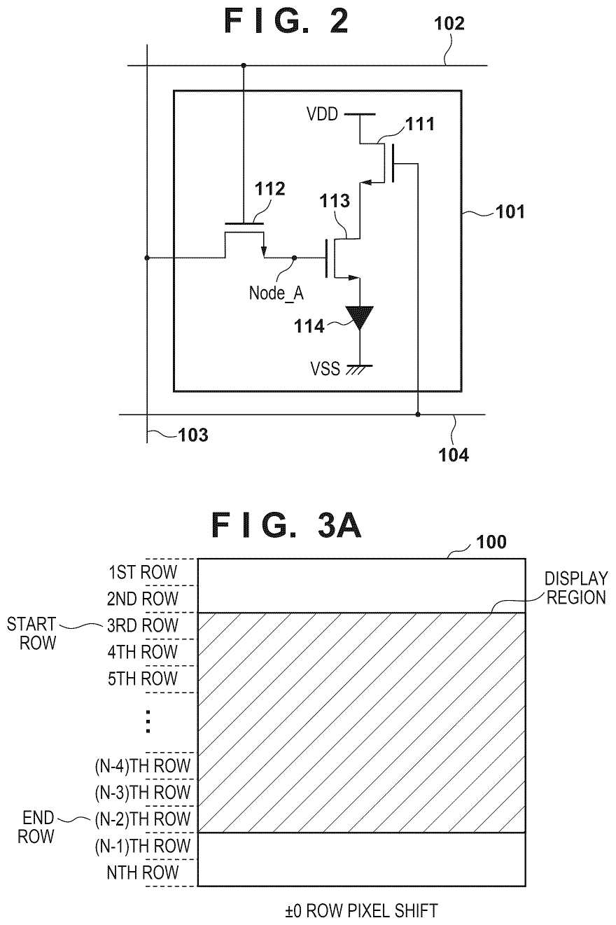

The light emitting device 100 includes a pixel array 110, a vertical scanning circuit 200, a signal output circuit 300, and a control circuit 400. The pixel array 110 includes a plurality of pixels 101 arranged in a two-dimensional array so as to form a plurality of rows and a plurality of columns. As described with reference to FIG. 2, each pixel 101 includes a light emitting element, and transistors for controlling image (luminance) signal writing and light emission. The pixel 101 is connected to the vertical scanning circuit 200 via a write control line 102 and a light emission control line 104 each commonly provided for each row. The pixel 101 is further connected to the signal output circuit 300 via an image signal line 103 commonly provided for each column. The signal output circuit 300 is controlled by the control circuit 400, and outputs an individual image signal for each column to the pixels 101. The vertical scanning circuit 200 is controlled by the control circuit 400. As will be described later in detail, the vertical scanning circuit 200 uses write control signals WR(1) to WR(N) supplied via the write control lines 102 to select the row (to be sometimes referred to as the write row hereinafter) to write the image signal from the pixel array 110, and uses light emission control signals EM(1) to EM(N) supplied via the light emission control lines 104 to select the row (to be sometimes referred to as the light emission row hereinafter) to cause light emission with the luminance corresponding to the written image signal. Here, N is an integer.

FIG. 2 is a circuit diagram showing an example of the arrangement of the pixel 101. The pixel 101 can include a light emission control transistor 111, a write transistor 112, a driving transistor 113, and a light emitting element 114. For the light emitting element 114, for example, an organic electroluminescence (EL) element, an inorganic EL element, a semiconductor laser element, a light emitting diode (LED), or the like can be used. The cathode terminal of the light emitting element 114 is connected to a supply line VSS at the ground level, and the anode terminal of the light emitting element 114 is connected to the source terminal of the driving transistor 113. The drain terminal of the driving transistor 113 is connected to the source terminal of the light emission control transistor 111, and the gate terminal of the driving transistor 113 is connected to the source terminal of the write transistor 112. The drain terminal of the light emission control transistor 111 is connected to a supply line VDD that supplies a power supply potential, and the gate terminal of the light emission control transistor 111 is connected to the light emission control line 104. The drain terminal of the write transistor 112 is connected to the image signal line 103, and the gate terminal of the write transistor 112 is connected to the write control line 102.

Next, an example of the operation of the pixel 101 will be described. When the write control line 102 is set at ON level (to be referred to as H level hereinafter), the write transistor 112 is set in the ON state (conductive state), and the signal voltage of the image signal line 103 is written in the Node_A connected to the gate terminal of the driving transistor 113. Then, when the write control line 102 is set at OFF level (to be referred to as L level hereinafter), the write transistor 112 is set in the OFF state (non-conductive state), and the signal voltage is held in the capacitive component of the Node_A. In this embodiment, examples of the capacitive component of the Node_A include the interconnection coupling capacitance, the gate-source parasitic capacitance of the driving transistor 113, and the gate-drain parasitic capacitance thereof. However, the capacitive component is not limited to these, and a capacitive element for holding the signal voltage written in the Node_A may be arranged. Then, when the light emission control line 104 is set at H level, the light emission control transistor 111 is set in the ON state, and a current corresponding to the voltage held in the Node_A connected to the gate terminal of the driving transistor 113 is supplied to the light emitting element 114. With this, the light emitting element 114 emits light with the luminance corresponding to the voltage held in the Node_A.

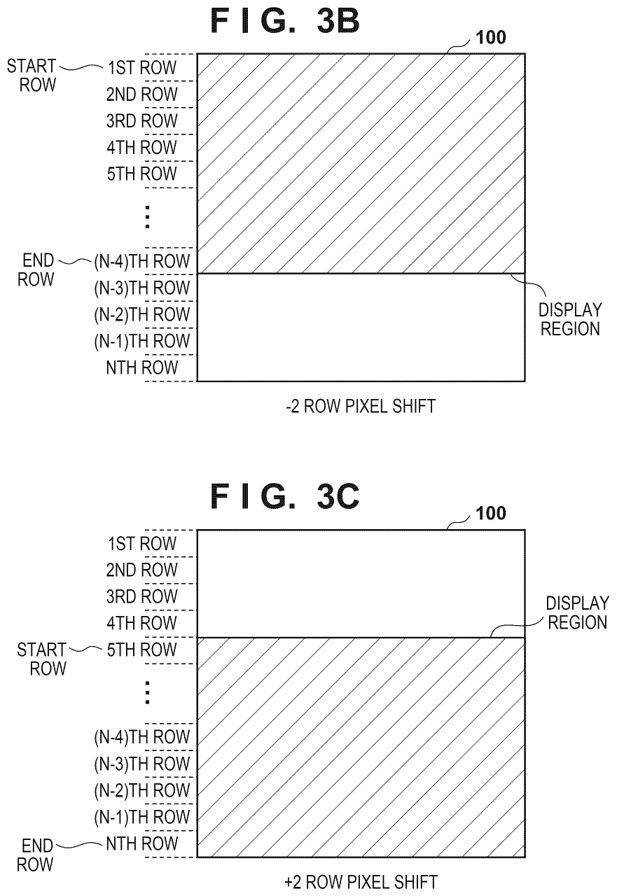

In this embodiment, the light emitting device 100 displays an image, a character, or the like (to be simply referred to as an “image” hereinafter) using some continuous rows of the pixel array 110, as shown in FIGS. 3A to 3C. Assume that, in the light emitting device 100 that includes the pixel array 110 including N rows, for example, a control signal for displaying an image corresponding to (N-4) rows is output from the control circuit 400. Of the total N rows, image signals are written in the pixels 101 in the predetermined (N-4) rows, and the light emitting elements 114 arranged in the pixels 101 emit light with the luminances corresponding to the written image signals. Thus, an image is displayed. It can be said that, in each frame for displaying an image, the pixel array 110 includes a display region formed by the rows where the pixels 101 in the light emission state are arranged among the plurality of rows, and a non-display region formed by the rows where the pixels 101 are in the non-light emission state among the plurality of rows. The positions of the display region and the non-display region are changed at a predetermined timing.

For example, FIG. 3A shows a case where the display region spans from the third row to (N-2)th row of the pixel array 110. This display region is defined as the shift ±0 row, and FIGS. 3B and 3C show a case where the image display region is shifted by −2 rows and the case where the image display region is shifted by +2 rows, respectively. When the display region is shifted by −2 rows, the image is displayed from the first row to the (N-4)th row. On the other hand, when the display region is shifted by +2 rows, the image is displayed from the fifth row to the Nth row. That is, as shown in FIGS. 3A and 3C, the row (start row) where the image display starts in the pixel array 110 may not be the row arranged at the end portion of the pixel array 110 on the first row side (one end side). In addition, as shown in FIGS. 3A and 3B, the row (end row) where the image display ends in the pixel array 110 may not be the row arranged at the end portion of the pixel array 110 on the Nth row side (the other end side). In this manner, by changing the display region while the light emitting device 100 is operating, it is possible to reduce the “image retention” phenomenon in which, when the same image is displayed for a long time, the light emission characteristic of the region where the same thing is kept displayed changes. Alternatively, the number of rows of the display region may be changed during the operation of the light emitting device 100. For example, when the start and end rows are set at the second and (N-1)th rows, respectively, the display region includes (N-2) rows. This means that the display region increases by two rows from the display regions shown in FIGS. 3A to 3C.

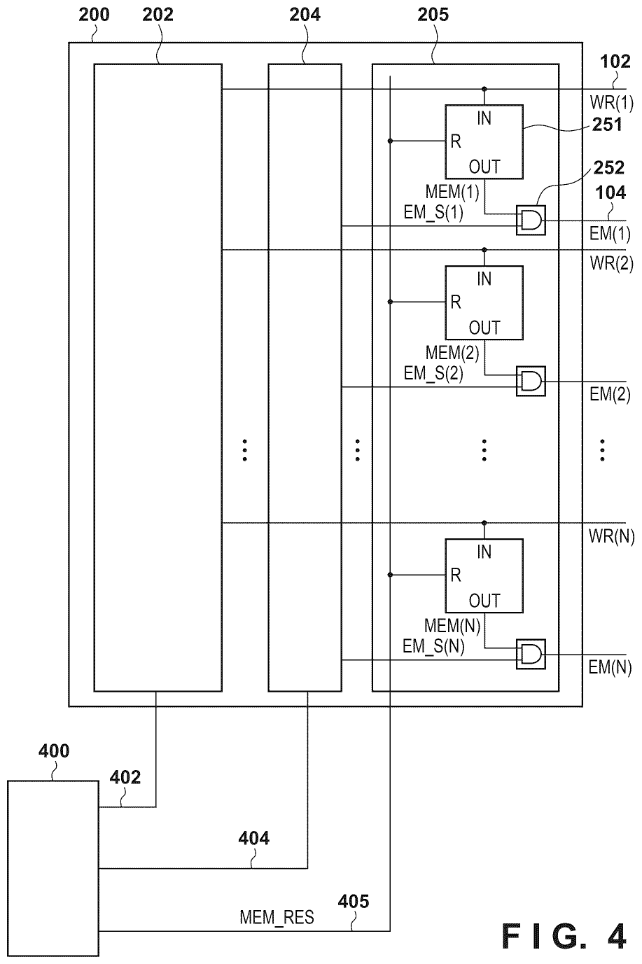

FIG. 4 is a view showing an example of the arrangement of the vertical scanning circuit 200 according to this embodiment. In this embodiment, a description will be given assuming that all logic circuits and logic gates operate in positive logic. When the write control signal WR(m) or the light emission control signal EM(m) is at H level, the corresponding transistor or circuit of the pixel 101 is set in the ON state, and an image signal write or light emission operation is performed. Here, m is an integer from 1 to N.

The vertical scanning circuit 200 includes a write control circuit 202, a light emission control circuit 204, and a light emission row gate circuit 205. The write control circuit 202 supplies the write control signal WR(m) to the selected row in order to write an image signal in the pixel 101 arranged in the selected row among the plurality of rows of the pixel array 110. More specifically, the write control circuit 202 receives a control signal from the control circuit 400 via a write row scanning control line 402, selects the row to write the image signal, and supplies the write control signal WR(m) to the write control line 102 for the selected row. The write control circuit 202 can be formed by, for example, a sequential circuit that combines a shift register and a logic circuit, or a logic circuit such as a decoder. In this embodiment, the write control circuit 202 supplies the write control signal WR(m) to the row forming the display region among the plurality of rows of the pixel array 110, and does not supply the write control signal WR(m) to the row forming the non-display region. That is, the image signal is not written in the pixel 101 in the row forming the non-display region.

The light emission control circuit 204 is arranged to supply the light emission control signal EM(m), which instructs light emission, to the selected row among the plurality of rows of the pixel array 110. More specifically, the light emission control circuit 204 receives a control signal from the control circuit 400 via a light emission row scanning control line 404, selects the row to cause light emission, and supplies a light emission control signal to the selected row. Here, in order to distinguish it from the light emission control signal EM(m) (to be described later) supplied from the light emission row gate circuit 205 to the pixel 101 arranged in the corresponding row, the light emission control signal supplied from the light emission control circuit 204 will be referred to as a light emission control intermediate signal EM_S(m). The light emission control intermediate signal EM_S(m) supplied from the light emission control circuit 204 is input to the light emission row gate circuit 205. The light emission control circuit 204 can be formed by, for example, a sequential circuit that combines a shift register, a decoder, a logic gate, and the like.

The light emission row gate circuit 205 includes a holding circuit 251 and a gate circuit 252. The holding circuit 251 includes an input terminal IN, an output terminal OUT, and a reset terminal R. The input terminal IN of the holding circuit 251 is connected to the write control line 102, and it can memorize that the write control signal WR(m) is supplied to the row including the holding circuit 251. The holding circuit 251 outputs a memory signal MEM(m) from the output terminal OUT in accordance with the holding state. For example, in this embodiment, the holding circuit 251 outputs L level in the initial state, and outputs H level when it memorizes that the write control signal WR(m) is supplied. The reset terminal R of the holding circuit 251 is supplied with a reset signal MEM_RES via a holding circuit reset control line 405. When the reset signal MEM_RES is set at H level, the holding circuit 251 resets the holding state to the initial state. The holding circuit 251 can be formed by, for example, a logic circuit such as an SR latch or a D flip flop.

In a case where the light emission control intermediate signal EM_S(m) is supplied to the gate circuit 252 from the light emission control circuit 204 and the holding circuit memorizes that the write control signal WR(m) is supplied, the gate circuit 252 outputs the light emission control signal EM(m) to the pixel 101 arranged in the row including the gate circuit 252. In this embodiment, the gate circuit 252 is a 2-input AND circuit. The memory signal MEM(m) output from the holding circuit 251 and the light emission control intermediate signal EM_S(m) sent from the light emission control circuit 204 are input to the input terminal of the gate circuit 252, and the output terminal is connected to the light emission control line 104. When L level is output from the holding circuit 251, the gate circuit 252 outputs L level, and when H level is output from the holding circuit 251, the gate circuit 252 outputs the light emission control intermediate signal EM_S(m) as the light emission control signal EM(m) to the light emission control line 104.

The holding circuit 251 and the gate circuit 252 may be arranged in each of the plurality of rows of the pixel array 110. However, they are not limited to this, and the holding circuit 251 and the gate circuit 252 may not be arranged in all rows. For example, in a case where only three types of display region shifts as shown in FIGS. 3A to 3C are performed, in each of the fifth to (N-4)th rows, which are always included in the display region regardless of the type of display region shift, the holding circuit 251 and the gate circuit 252 are not arranged, and the light emission control intermediate signal EM_S(m) output from the light emission control circuit 204 may be output intact as the light emission control signal EM(m) to the light emission control line 104. That is, the holding circuit 251 and the gate circuit 252 may be arranged in each of the first to fourth rows and the (N-3)th to Nth rows, which are changed between the display region and the non-display region.

A signal for selecting the start and end rows to specify the display region may be supplied from the control circuit 400 to the write control circuit 202 and the light emission control circuit 204. The signal for selecting the start and end rows can be supplied, for example, from the control circuit 400 to the write control circuit 202 and the light emission control circuit 204 via the write row scanning control line 402 and the light emission row scanning control line 404, respectively.

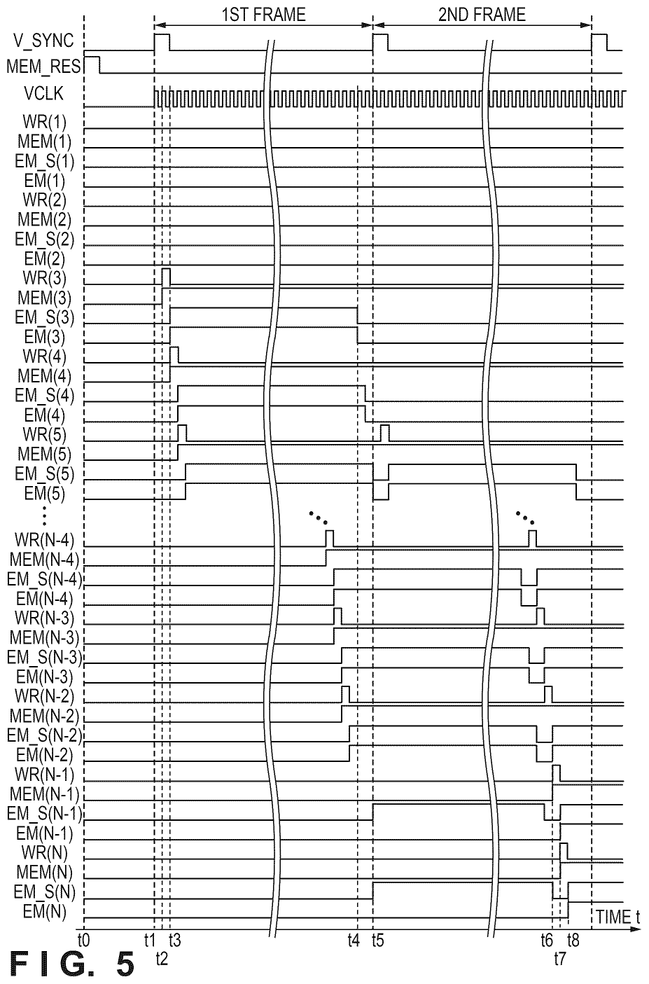

FIG. 5 is a chart showing the operation timings of the light emitting device 100 according to this embodiment. FIG. 5 is a timing chart in a case where the light emitting device 100 is powered on, and it is operated with the display region shown in FIG. 3A in the first frame, and with the display region shown in FIG. 3C in the subsequent second frame.

At time t0, the light emitting device 100 is powered on, and the reset signal MEM_RES is supplied from the control circuit 400 to the holding circuit 251 via the holding circuit reset control line 405 to reset all the holding circuits 251. That is, before the first frame to display an image starts, memories of the holding circuits 251 are reset. At time t0, the control circuit 400 may also supply reset signals via the write row scanning control line 402 and the light emission row scanning control line 404 to reset the circuits included in the write control circuit 202 and the light emission control circuit 204. Here, time t0 is defined as the timing when the light emitting device 100 is powered on, but the present disclosure not limited to this. For example, time t0 may be the timing when the image displayed in the pixel array 110 is switched. Alternatively, for example, time t0 may be the timing when all the holding circuits 251 are reset at an appropriate timing such as a predetermined time interval.

At time t1, a vertical synchronization signal V_SYNC is generated in the control circuit 400, and the operation in the first frame is started. In accordance with the start of the operation in the first frame, a clock signal VCLK is output from the control circuit 400, and supplied to the light emission control circuit 204 via the light emission row scanning control line 404. In accordance with the clock signal VCLK, the light emission control circuit 204 sequentially selects the row to emit light. Corresponding to the display region in the first frame, the third row is set as the start row, and the (N-2)th row is set as the end row.

Then, at time t2, the write control circuit 202 that receives a control signal from the control circuit 400 via the write row scanning control line 402 selects, as the write row, the third row corresponding to the start row, and the write control signal WR(3) at H level is supplied. The period during which the write control signal WR(m) at H level is supplied is the write period for the mth row. The write control signal WR(3) is input to the holding circuit 251 in the third row, and the holding circuit 251 memorizes the information that writing is performed in the third row. Accordingly, a signal at H level is output as the memory signal MEM(3). In the following description, the period during which the write control signal WR(m) is at H level is the period during which the write control signal WR(m) is supplied. The period during which the write control signal WR(m) is at L level is the period during which the write control signal WR(m) is not supplied. This also applies to the light emission control intermediate signal EM_S(m) and the like.

At time t3, to end the selection of the third row as the write row, the write control circuit 202 sets the write control signal WR(3) at L level. In addition, the fourth row is newly selected as the write row, and the write control signal WR(4) at H level is supplied. Similar to the third row, the write control signal WR(4) is input to the holding circuit 251 in the fourth row, and the holding circuit 251 memorizes the information that writing is performed in the fourth row. Accordingly, a signal at H level is output as the memory signal MEM(4). From the fourth row to the (N-2)th row, the write row is selected similarly, and the image signal is written in each row up to the (N-2)th row.

In addition, at time t3, the light emission control circuit 204 that receives a control signal from the control circuit 400 via the light emission row scanning control line 404 selects, as the light emission row, the third row where writing is completed, and supplies the light emission control intermediate signal EM_S(3) at H level. The light emission control intermediate signal EM_S(3) and the memory signal MEM(3) are input to the gate circuit 252 and, since the memory signal MEM(3) is at H level, the light emission control intermediate signal EM_S(3) is output as the light emission control signal EM(3) from the gate circuit 252 to the light emission control line 104. The period during which the light emission control signal EM(m) at H level is supplied is the light emission period. In the light emission period, the pixel 101 in the mth row emits light with the luminance corresponding to the written image signal. After this, similarly, up to the (N-2)th row, the light emission row is sequentially selected by the shift register circuit in the light emission control circuit 204, which is operated based on the clock signal VCLK, and each row up to the (N-2)th row sequentially starts the light emission period.

At time t4, the light emission control intermediate signal EM_S(3) is set at L level, and the light emission period in the third row ends. The light emission periods in the fourth and subsequent rows also end sequentially. In addition, at time t4, for the (N-1)th row, the shift register in the light emission control circuit 204 outputs the signal at H level to start the light emission period in the (N-1)th row. However, since the (N-1)th row is outside the display region in the first frame, the output from the shift register in the light emission control circuit 204 is gated by the logic circuit in the light emission control circuit 204, and the light emission control intermediate signal EM_S(N-1) remains at L level until time t5. This also applies to the (N)th row, and the light emission control intermediate signal EM_S(N) remains at L level until time t5.

By time t5, the write control signals WR(m) are supplied to the pixels 101 in all rows in the display region in the first frame, and the image signals are written therein. Here, as shown in FIG. 5, each frame period is the period during which the write control signals WR(m) are supplied to the pixels 101 in all rows of the display region. As shown in FIG. 5, in some rows, the light emission period continues to the second frame after the image signal is written in the first frame.

At time t5, the vertical synchronization signal V_SYNC is generated in the control circuit 400, the display region is changed, and the operation in the second frame is started. In the second frame, in accordance with the display region shift, the fifth row is set as the start row, and the (N)th row is set as the end row. Accordingly, each of the (N-1)th and (N)th rows, which is outside the display region so that the output from the shift register in the light emission control circuit 204 is gated in the first frame, becomes the display region in the second frame. Therefore, the light emission control intermediate signals EM_S(N-1) and EM_S(N) at H level are output. This is because, in each frame, the light emission control circuit 204 supplies the light emission control intermediate signal EM_S(m) as the light emission control signal to the row forming the display region among the plurality of rows over a predetermined period corresponding to each row.

However, after the holding circuits 251 are reset at time t0, the write control signals WR(N-1) and WR(N) are not supplied to the (N-1)th and Nth rows. Therefore, the holding circuits 251 in the (N-1)th and Nth rows output the memory signals MEM(N-1) and MEM(N) at L level. Accordingly, the gate circuits 252 in the (N-1)th and Nth rows do not output the light emission control intermediate signals EM_S(N-1) and EM_S(N) to the light emission control lines 104, so that the light emission control signal EM(N-1) remains at L level.

Consider a case where, when the row outside the display region switches to the display region due to the display region shift performed at time t5, the holding circuit 251 configured to hold and memorize the information on whether the write control signal WR(m) is supplied is not provided, unlike this embodiment. In this case, from time t5, the light emission control intermediate signals EM_S(N-1) and EM_S(N) at H level are output as the light emission control signals EM(N-1) and EM(N) to the light emission control lines 104 and supplied to the pixels 101. No image signal has been written in the pixels 101 in the (N-1)th and Nth rows after the power-on at time t0. Therefore, the light emission control signals EM(N-1) and EM(N) are supplied while the voltage in the Node_A shown in FIG. 2 is unstable. In this case, light is emitted with unintended luminance from each of the (N-1)th and Nth rows where the writing has not been performed after the power-on, and this can affect display quality. To prevent this, in this embodiment, the holding circuit 251 and the gate circuit 252 are provided to prevent the light emission control signal EM(m) from being supplied to the row where no image signal has been written. With this, light emission of the pixel 101 with unintended luminance is prevented. As a result, display quality can be improved.

At time t6, the write control circuit 202 that receives a control signal from the control circuit 400 via the write row scanning control line 402 selects the (N-1)th row as the write row, and the holding circuit 251 in the (N-1)th row outputs the memory signal MEM(N-1) at H level. Similarly, at time t7, the holding circuit 251 in the Nth row outputs the memory signal MEM(N) at H level. In addition, at time t7, the light emission control intermediate signal EM_S(N-1) at H level and the memory signal MEM(N-1) at H level are input to the gate circuit 252. Then, the light emission control intermediate signal EM_S(N-1) at H level is output as the light emission control signal EM(N-1) to the pixel 101 in the (N-1)th row. At time t8, in the Nth row, the light emission control intermediate signal EM_S(N) at H level is similarly output as the light emission control signal EM(N) to the pixel 101 in the Nth row.

This embodiment is merely an example. For example, a result of logical operation between the signal supplied from the control circuit 400 and the light emission control intermediate signal EM_S(m) obtained in the gate circuit 252 may be output as the light emission control signal EM(m) to the pixel 101. Each of the light emission control signal EM(m) and the write control signal WR(m) does not have to be of one type. The holding circuit 251 may use another signal equivalent to the write control signal WR(m) to memorize the row write history. When a write or light emission operation is performed in each row, the light emission control signal EM(m) or the write control signal WR(m) need not be fixed at H level, and may be at L level at some timing. Not all circuits need to operate in positive logic, and some or all circuits may operate in negative logic.

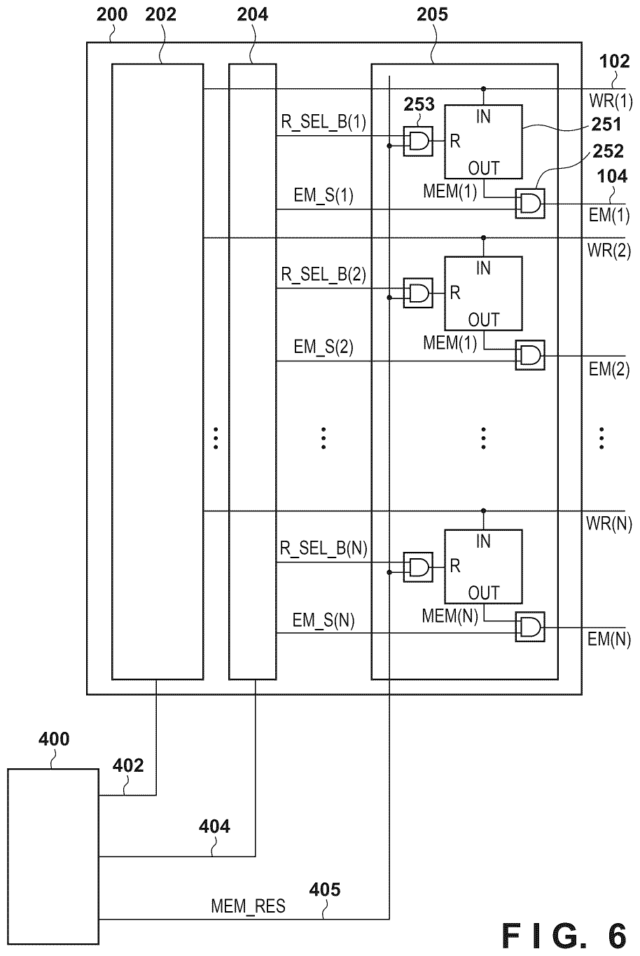

FIG. 6 shows an example of the arrangement of the vertical scanning circuit 200, which is a modification of the vertical scanning circuit 200 described with reference to FIG. 4. A description of components that may be similar to those shown in FIG. 4 will be omitted appropriately, and differences will mainly be described. In the light emission row gate circuit 205 shown in FIG. 6, a reset gate circuit 253 is provided for each row. As in the above description, the holding circuit 251, the gate circuit 252, and the reset gate circuit 253 may not be arranged in the row which is always included in the display region.

The reset gate circuit 253 is a circuit having a function of, in accordance with a region selection signal R_SEL_B(m) supplied from the light emission control circuit 204, gating whether the reset signal MEM_RES output from the control circuit 400 is supplied to the holding circuit 251. The reset gate circuit 253 can be implemented by, for example, a 2-input AND circuit. If the mth row is the row included in the display region in the current frame, the light emission control circuit 204 outputs the region selection signal R_SEL_B(m) at L level; otherwise, the light emission control circuit 204 outputs H level. If the region selection signal R_SEL_B(m) at H level is input, the reset gate circuit 253 outputs the input reset signal MEM_RES. If the region selection signal R_SEL_B(m) at L level is input, the reset gate circuit 253 does not output MEM_RES, and the output remains fixed at L level.

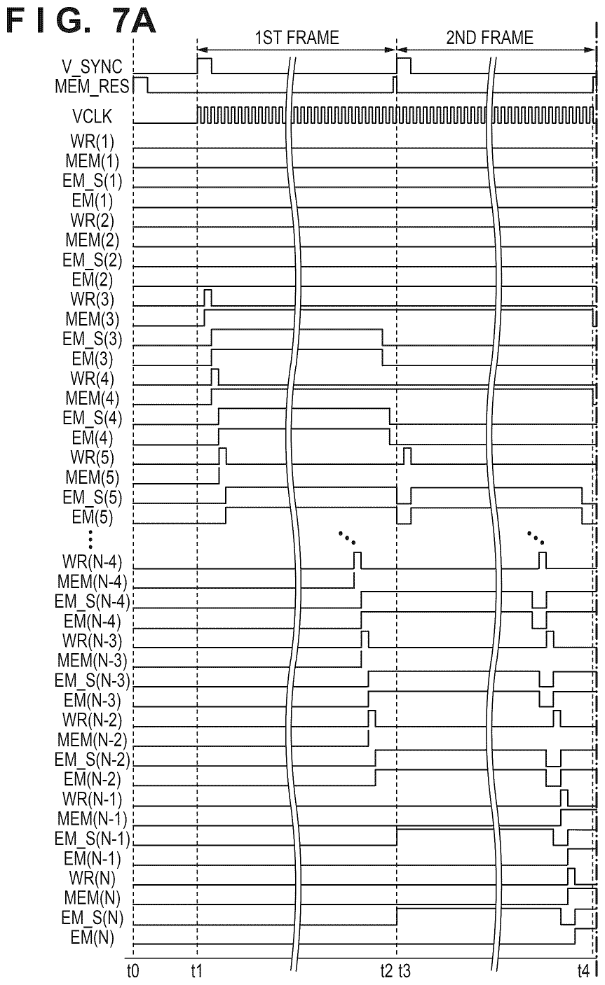

FIGS. 7A and 7B are views showing the operation timings of the light emitting device 100 including the vertical scanning circuit 200 shown in FIG. 6. FIGS. 7A and 7B show the driving waveforms in a case where the light emitting device 100 is powered on, and it is operated with the display region shown in FIG. 3A in the first frame, with the display region shown in FIG. 3C in the second frame, with the display region shown in FIG. 3A in the third frame, and with the display region shown in FIG. 3C in the fourth frame. A description of the driving waveforms and operations similar to those in FIG. 5 will appropriately be omitted.

At time t0, the light emitting device 100 is powered on. At this time, as the initial state, all the region selection signals R_SEL_B(m) are at H level. The reset signal MEM_RES as the reset signal is set at H level, and then set at L level by time t1 when the first frame starts. At this time, since all the region selection signals R_SEL_B(m) are at H level, the memories of the holding circuits 251 in all rows are reset by the reset signal MEM_RES.

At time t1, the vertical synchronization signal V_SYNC is generated in the control circuit 400, and the operation in the first frame is started. After this, the operations until time t2 are similar to the operations shown in FIG. 5.

At time t2, the reset signal MEM_RES is set at H level. At this time, only the region selection signals R_SEL_B(m) for the first, second, (N-1)th, and Nth rows, which are not included in the display region in the first frame, are set at H level. Accordingly, the holding circuits 251 in the first, second, (N-1)th, and Nth rows are reset.

Then, at time t3, the reset signal MEM_RES is set at L level, and the reset operation of the holding circuits 251 ends. The display region is changed, and the operation in the second frame is started.

At time t4, the reset signal MEM_RES is set at H level. The holding circuits 251 in the first to fourth rows, which are not included in the display region in the second frame, are reset. Accordingly, the holding circuits 251 in the third and fourth rows, which memorize from the first frame that the write control signals WR(m) are supplied, are reset, and the memory signals MEM(3) and MEM(4) are set at L level.

Then, at time t5, the display region is changed. The output from the shift register in the light emission control circuit 204 for each of the (N-1)th and Nth rows, which are no longer included in the display region, is gated by the logic circuit in the light emission control circuit 204. Accordingly, the light emission control intermediate signals EM_S(N-1) and EM_S(N) are set at L level. Due to this, the light emission period in each of the (N-1)th and Nth rows, which are no longer included in the display region, becomes shorter than the original light emission period. However, the light emission periods do not become shorter in the other rows. After time t5, operations similar to those in the first frame are performed until time t6.

At time t6, the reset signal MEM_RES is set at H level. At this time, the holding circuits 251 in the first, second, (N-1)th, and Nth rows, which are not selected as the light emission rows, are reset. Accordingly, the holding circuits 251 in the (N-1)th and Nth rows, which memorize from the second frame that the write control signals WR(m) are supplied, are reset, and the memory signals MEM(N-1) and MEM(N) are set at L level. From time t6, operations similar to those in the second frame are performed until time t7.

Here, if the display region is not changed in the next frame, the reset signal MEM_RES may not be input. For example, if the display region is not changed between the fourth frame and the fifth frame starting from time t8, the reset signal MEM_RES may not be set at H level at time t7.

In this embodiment, in each frame from the second frame, before the write control circuit 202 starts to supply the write control signals WR(m), the memory of the holding circuit 251 in the row forming the non-display region among the plurality of rows of the pixel array 110 in the immediately preceding frame is reset. With this, not only in a case where the display region is changed only once after power-on but also in a case where the display region is changed many times during driving of the light emitting device 100, it is possible to prevent light emission with unintended luminance from the row changed from the non-display region to the display region.

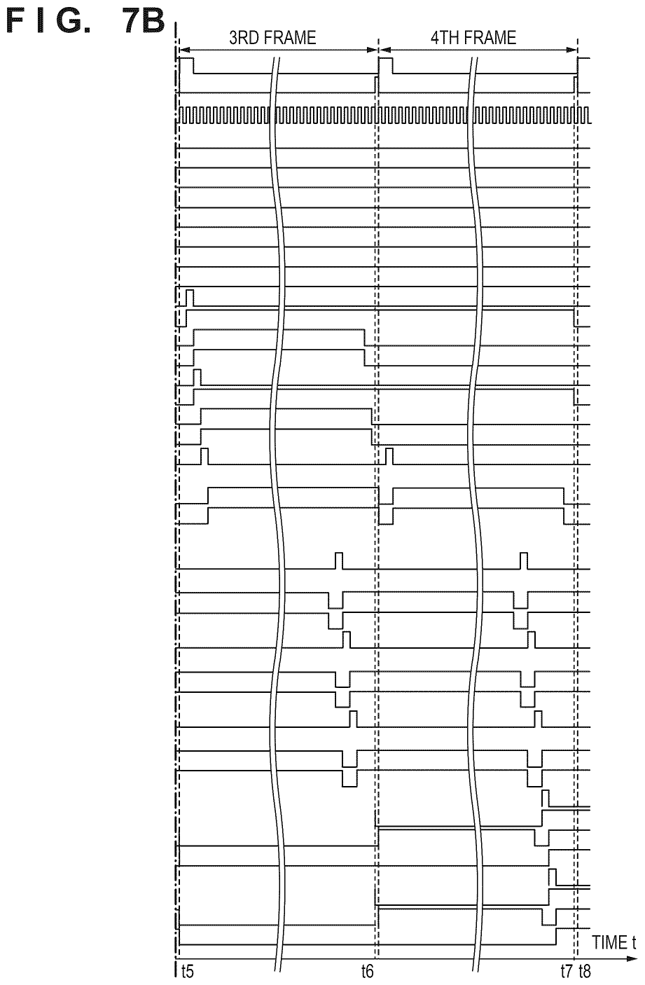

FIG. 8 shows an example of the arrangement of the vertical scanning circuit 200, which is a modification of the vertical scanning circuit 200 described with reference to FIG. 4. A description of components that may be similar to those shown in FIG. 4 will be omitted appropriately, and differences will mainly be described. The light emission row gate circuit 205 shown in FIG. 8 is provided with a holding circuit 254 with a trigger reset instead of the holding circuit 251. As in the above description, the holding circuit 254 and the gate circuit 252 may not be arranged in the row which is always included in the display region.

In addition to the function of the holding circuit 251, the holding circuit 254 has a function of resetting the holding/memorizing state to the initial state with the transition of the light emission control signal EM(m) input to a trigger reset terminal TR from H level to L level as a trigger. In this embodiment, the light emission control signal EM(m) is input to the trigger reset terminal TR of the holding circuit 254, and the holding circuit 254 is also reset when the light emission control signal EM(m) input to the TR terminal transitions from H level to L level, that is, when the light emission period ends.

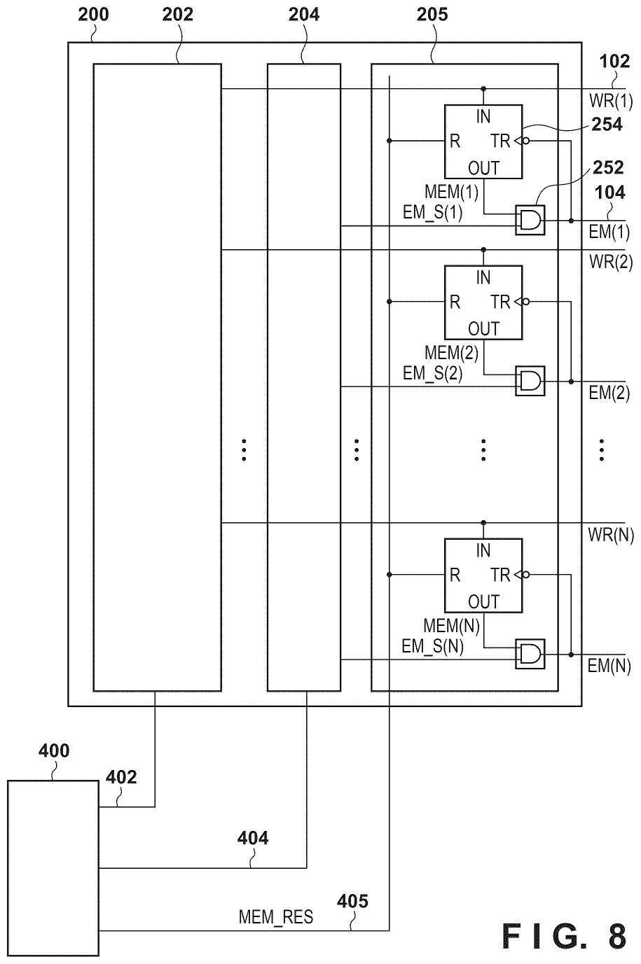

FIG. 9 is a chart showing the operation timings of the light emitting device 100 including the vertical scanning circuit 200 shown in FIG. 8. FIG. 9 shows driving waveforms in a case where the light emitting device 100 is powered on, and it is operated with the display region shown in FIG. 3A in the first frame, with the display region shown in FIG. 3C in the second frame, and with the display region shown in FIG. 3A in the third frame, as in the operations shown in FIGS. 7A and 7B. A description of the driving waveforms and operations similar to those in FIGS. 7A and 7B will appropriately be omitted.

At time t0, the light emitting device 100 is powered on. At this time, the reset signal MEM_RES is set at H level, and then set at L level by time t1 when the first frame starts. Accordingly, the memory of each holding circuit 254 is reset before the first frame starts. At time t1, the vertical synchronization signal V_SYNC is generated in the control circuit 400, and the operation in the first frame is started.

At time t2, in the third row, which is the start row in the first frame, the light emission control signal EM(3) transitions from H level to L level, and the light emission period ends. In the holding circuit 254 in the third row, with the transition of the light emission control signal EM(3) from H level to L level as a trigger, the memory indicating that the write control signal WR(3) is supplied in the first frame is reset, and the memory signal MEM(3) is set at L level. In each embodiment described above, it is described that, at time t2, the output from the shift register in the light emission control circuit 204 in the row, which is from the end row so not included in the display region, is gated by the logic circuit and the light emission control intermediate signal EM_S(N-1) remains at L level. However, in this example, the output from the shift register is output intact as the light emission control intermediate signal EM_S(N-1). That is, at time t2, the light emission control intermediate signal EM_S(N-1) at H level is output. Here, since no image signal has been written in the (N-1)th row after the reset operation from time t0, the memory signal MEM(N-1) is at L level. Therefore, the light emission control intermediate signal EM_S(N-1) is at H level, but the light emission control signal EM(N-1) output from the gate circuit 252 remains at L level. That is, the light emission control signal EM(N-1) is not output from the gate circuit 252 to the pixel in the (N-1)th row.

Then, at time t3, similar to the third row at time t2, in the holding circuit 254 in the fourth row, with the transition of the light emission control signal EM(4) from H level to L level as a trigger, the memory indicating that the write control signal WR(4) is supplied in the first frame is reset, and the memory signal MEM(4) is set at L level. At time t3, for the Nth row as well, similar to the (N-1)th row at time t2, the light emission control intermediate signal EM_S(N) at H level is output. However, since the memory signal MEM(N) is at L level, the light emission control signal EM(N) remains at L level.

Here, in the operations shown in FIG. 9, as an example, the transition of the light emission control signal EM(3) and the transition of the light emission control signal EM(N-1) occur at the same time at time t2, and the transition of the light emission control signal EM(4) and the transition of the light emission control signal EM(N) occur at the same time at time t3. However, these transitions need not occur at the same time. Subsequently, by time t5, the light emission period in each row up to the (N-2)th row sequentially ends, and the holding circuit 254 in each row is sequentially reset when the light emission period ends. That is, in the row forming the display region, the memory of the holding circuit 254 is reset when supply of the light emission control signal EM(m) ends.

At time t4, the operation in the second frame is started. Sequentially from the fifth row as the start row, the write control signal WR(m) is supplied, and then the light emission control signal EM(m) is supplied. At time t6, the operation in the third frame is started. Sequentially from the third row as the start row, the write control signal WR(m) is supplied, and then the light emission control signal EM(m) is supplied.

As shown in FIG. 9, by resetting the holding circuit 254 in each row when the light emission period in each row ends, erroneous light emission caused by changing the display region can be prevented. Furthermore, as shown in FIGS. 7A and 7B, the problem that the light emission period in the row changed from the display region to the non-display region becomes shorter than the original light emission period is solved. In the description of this embodiment, the holding circuit 254 is reset using the light emission control signal EM(m), but an appropriate signal may be supplied to the holding circuit 254 at a similar timing.

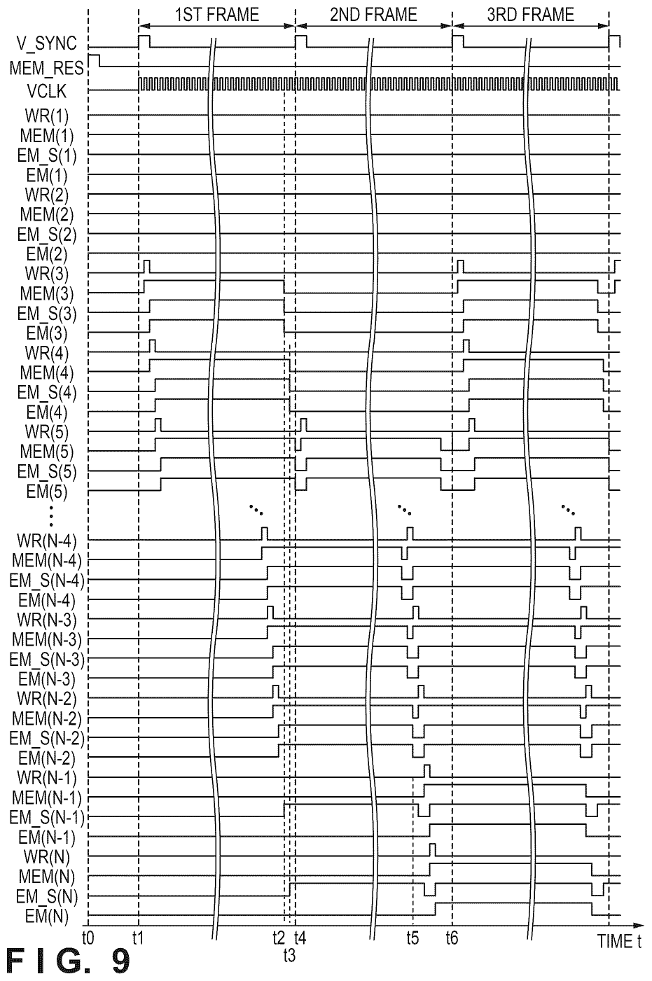

Here, application examples in which the light emitting device 100 according to this embodiment is applied to an image forming device, a display device, a photoelectric conversion device, an electronic apparatus, an illumination device, a moving body, and a wearable device will be described with reference to FIGS. 10A to 18B. The description will be given assuming that, for example, as described above, an organic light emitting element such as an organic EL element is arranged as the light emitting element 114 in the pixel 101 arranged in the pixel array 110 of the light emitting device 100. Details of each component arranged in the pixel array 110 of the light emitting device 100 described above will be described first, and the application examples will be described after that.

### Arrangement of Organic Light Emitting Element

The organic light emitting element is provided by forming an insulating layer, a first electrode, an organic compound layer, and a second electrode on a substrate. A protection layer, a color filter, a microlens, and the like may be provided on a cathode. If a color filter is provided, a planarizing layer may be provided between the protection layer and the color filter. The planarizing layer can be formed using acrylic resin or the like. The same applies to a case where a planarizing layer is provided between the color filter and the microlens.

### Substrate

Quartz, glass, a silicon wafer, a resin, a metal, or the like may be used as a substrate. Furthermore, a switching element such as a transistor, a wiring pattern, and the like may be provided on the substrate, and an insulating layer may be provided thereon. The insulating layer may be made of any material as long as a contact hole can be formed so that the wiring pattern can be formed between the first electrode and the substrate and insulation from the unconnected wiring pattern can be ensured. For example, a resin such as polyimide, silicon oxide, silicon nitride, or the like may be used for the insulating layer.

### Electrode

A pair of electrodes can be used as the electrodes. The pair of electrodes can be an anode and a cathode. If an electric field is applied in the direction in which the organic light emitting element emits light, the electrode having a high potential is the anode, and the other is the cathode. It can also be said that the electrode that supplies holes to the light emitting layer is the anode and the electrode that supplies electrons is the cathode.

As the constituent material of the anode, a material having a large work function may be selected. For example, a metal such as gold, platinum, silver, copper, nickel, palladium, cobalt, selenium, vanadium, or tungsten, a mixture containing some of them, an alloy obtained by combining some of them, or a metal oxide such as tin oxide, zinc oxide, indium oxide, indium tin oxide (ITO), or zinc indium oxide can be used. Furthermore, a conductive polymer such as polyaniline, polypyrrole, or polythiophene can also be used as the constituent material of the anode.

One of these electrode materials may be used singly, or two or more of them may be used in combination. The anode may be formed by a single layer or a plurality of layers.

If the electrode is used as a reflective electrode, for example, chromium, aluminum, silver, titanium, tungsten, molybdenum, an alloy thereof, a stacked layer thereof, or the like can be used. The above materials can function as a reflective film having no role as an electrode. If a transparent electrode is used as the electrode, an oxide transparent conductive layer made of indium tin oxide (ITO), indium zinc oxide, or the like can be used, but the present disclosure is not limited thereto. A photolithography technique can be used to form the electrode.

On the other hand, as the constituent material of the cathode, a material having a small work function may be selected. Examples of the material include an alkali metal such as lithium, an alkaline earth metal such as calcium, a metal such as aluminum, titanium, manganese, silver, lead, or chromium, and a mixture containing some of them. Alternatively, an alloy obtained by combining these metals can also be used. For example, a magnesium-silver alloy, an aluminum-lithium alloy, an aluminum-magnesium alloy, a silver-copper alloy, a zinc-silver alloy, or the like can be used. A metal oxide such as indium tin oxide (ITO) can also be used. One of these electrode materials may be used singly, or two or more of them may be used in combination. The cathode may have a single-layer structure or a multilayer structure. Silver may be used as the cathode. To suppress aggregation of silver, a silver alloy may be used. The ratio of the alloy is not limited as long as aggregation of silver can be suppressed. For example, the ratio between silver and another metal may be 1:1, 3:1, or the like.

The cathode may be a top emission element using an oxide conductive layer made of ITO or the like, or may be a bottom emission element using a reflective electrode made of aluminum (Al) or the like, and is not particularly limited. The method of forming the cathode is not particularly limited, but if direct current sputtering or alternating current sputtering is used, good coverage of the formed film can be achieved, and the resistance of the cathode can be lowered.

### Pixel Isolation Layer

A pixel isolation layer may be formed by a so-called silicon oxide, such as silicon nitride (SiN), silicon oxynitride (SiON), or silicon oxide (SiO), formed using a Chemical Vapor Deposition (CVD) method. To increase the resistance in the in-plane direction of the organic compound layer, the organic compound layer, especially the hole transport layer may be thinly deposited on the side wall of the pixel isolation layer. More specifically, the organic compound layer can be deposited so as to have a thin film thickness on the side wall by increasing the taper angle of the side wall of the pixel isolation layer or the film thickness of the pixel isolation layer to increase vignetting during vapor deposition.

On the other hand, the taper angle of the side wall of the pixel isolation layer or the film thickness of the pixel isolation layer can be adjusted to the extent that no space is formed in the protection layer formed on the pixel isolation layer. Since no space is formed in the protection layer, it is possible to reduce generation of defects in the protection layer. Since generation of defects in the protection layer is reduced, a decrease in reliability caused by generation of a dark spot or occurrence of a conductive failure of the second electrode can be reduced.

According to this embodiment, even if the taper angle of the side wall of the pixel isolation layer is not acute, it is possible to effectively suppress leakage of charges to an adjacent pixel. As a result of this consideration, it has been found that the taper angle of 60° (inclusive) to 90° (inclusive) can sufficiently reduce the occurrence of defects. The film thickness of the pixel isolation layer may be 10 nm (inclusive) to 150 nm (inclusive). A similar effect can be obtained in an arrangement including only pixel electrodes without the pixel isolation layer. However, in this case, the film thickness of the pixel electrode is set to be equal to or smaller than half the film thickness of the organic layer or the end portion of the pixel electrode is formed to have a forward tapered shape of less than 60°. With this, short circuit of the organic light emitting element can be reduced.

Furthermore, in a case where the first electrode is the cathode and the second electrode is the anode, a high color gamut and low-voltage driving can be achieved by forming the electron transport material and charge transport layer and forming the light emitting layer on the charge transport layer.

### Organic Compound Layer

The organic compound layer may be formed by a single layer or a plurality of layers. If the organic compound layer includes a plurality of layers, the layers can be called a hole injection layer, a hole transport layer, an electron blocking layer, a light emitting layer, a hole blocking layer, an electron transport layer, and an electron injection layer in accordance with the functions of the layers. The organic compound layer is mainly formed from an organic compound but may contain inorganic atoms and an inorganic compound. For example, the organic compound layer may contain copper, lithium, magnesium, aluminum, iridium, platinum, molybdenum, zinc, or the like. The organic compound layer may be arranged between the first and second electrodes, and may be arranged in contact with the first and second electrodes.

### Protection Layer

A protection layer may be provided on the cathode. For example, by adhering glass provided with a moisture absorbing agent on the cathode, permeation of water or the like into the organic compound layer can be suppressed and occurrence of display defects can be suppressed. Furthermore, as another embodiment, a passivation layer made of silicon nitride or the like may be provided on the cathode to suppress permeation of water or the like into the organic compound layer. For example, the protection layer can be formed by forming the cathode, transferring it to another chamber without breaking the vacuum, and forming silicon nitride having a thickness of 2 μm by the CVD method. The protection layer may be provided using an atomic layer deposition (ALD) method after deposition of the protection layer using the CVD method. The material of the protection layer by the ALD method is not limited but can be silicon nitride, silicon oxide, aluminum oxide, or the like. Silicon nitride may further be formed by the CVD method on the protection layer formed by the ALD method. The protection layer formed by the ALD method may have a film thickness smaller than that of the protection layer formed by the CVD method. More specifically, the film thickness of the protection layer formed by the ALD method may be 50% or less, or 10% or less of that of the protection layer formed by the CVD method.

### Color Filter

A color filter may be provided on the protection layer. For example, a color filter considering the size of the organic light emitting element may be provided on another substrate, and the substrate with the color filter formed thereon may be bonded to the substrate with the organic light emitting element provided thereon. Alternatively, for example, a color filter may be patterned on the above-described protection layer using a photolithography technique. The color filter may be formed from a polymeric material.

### Planarizing Layer

A planarizing layer may be arranged between the color filter and the protection layer. The planarizing layer is provided to reduce unevenness of the layer below the planarizing layer. The planarizing layer may be called a material resin layer without limiting the purpose of the layer. The planarizing layer may be formed from an organic compound, and may be made of a low-molecular material or a polymeric material. In consideration of reduction of unevenness, a polymeric organic compound may be used for the planarizing layer.

The planarizing layers may be provided above and below the color filter. In that case, the same or different constituent materials may be used for these planarizing layers. More specifically, examples of the material of the planarizing layer include polyvinyl carbazole resin, polycarbonate resin, polyester resin, ABS resin, acrylic resin, polyimide resin, phenol resin, epoxy resin, silicone resin, and urea resin.

### Microlens

The organic light emitting device may include an optical member such as a microlens on the light emission side. The microlens can be made of acrylic resin, epoxy resin, or the like. The microlens can aim to increase the amount of light extracted from the organic light emitting device and control the direction of light to be extracted. The microlens can have a hemispherical shape. If the microlens has a hemispherical shape, among tangents contacting the hemisphere, there is a tangent parallel to the insulating layer, and the contact between the tangent and the hemisphere is the vertex of the microlens. The vertex of the microlens can be decided in the same manner even in an arbitrary sectional view. That is, among tangents contacting the semicircle of the microlens in a sectional view, there is a tangent parallel to the insulating layer, and the contact between the tangent and the semicircle is the vertex of the microlens.

Furthermore, the midpoint of the microlens can also be defined. In the section of the microlens, a line segment from a point at which an arc shape ends to a point at which another arc shape ends is assumed, and the midpoint of the line segment can be called the midpoint of the microlens. A section for determining the vertex and the midpoint may be a section perpendicular to the insulating layer.

The microlens includes a first surface including a convex portion and a second surface opposite to the first surface. The second surface can be arranged on the functional layer (light emitting layer) side of the first surface. For this arrangement, the microlens needs to be formed on the light emitting device. If the functional layer is an organic layer, a process which produces high temperature in the manufacturing step of the microlens may be avoided. In addition, if it is configured to arrange the second surface on the functional layer side of the first surface, all the glass transition temperatures of an organic compound forming the organic layer may be 100° C. or more. For example, 130° C. or more is suitable.

### Counter Substrate

A counter substrate may be arranged on the planarizing layer. The counter substrate is called a counter substrate because it is provided at a position corresponding to the above-described substrate. The constituent material of the counter substrate can be the same as that of the above-described substrate. If the above-described substrate is the first substrate, the counter substrate can be the second substrate.

### Organic Layer

The organic compound layer (hole injection layer, hole transport layer, electron blocking layer, light emitting layer, hole blocking layer, electron transport layer, electron injection layer, and the like) forming the organic light emitting element according to an embodiment of the present disclosure may be formed by the method to be described below.

The organic compound layer forming the organic light emitting element according to the embodiment of the present disclosure can be formed by a dry process using a vacuum deposition method, an ionization deposition method, a sputtering method, a plasma method, or the like. Instead of the dry process, a wet process that forms a layer by dissolving a solute in an appropriate solvent and using a well-known coating method (for example, a spin coating method, a dipping method, a casting method, an LB method, an inkjet method, or the like) can be used.

Here, when the layer is formed by a vacuum deposition method, a solution coating method, or the like, crystallization or the like hardly occurs and excellent temporal stability is obtained. Furthermore, when the layer is formed using a coating method, it is possible to form the film in combination with a suitable binder resin.

Examples of the binder resin include polyvinyl carbazole resin, polycarbonate resin, polyester resin, ABS resin, acrylic resin, polyimide resin, phenol resin, epoxy resin, silicone resin, and urea resin. However, the binder resin is not limited to them.

One of these binder resins may be used singly as a homopolymer or a copolymer, or two or more of them may be used in combination. Furthermore, additives such as a well-known plasticizer, antioxidant, and an ultraviolet absorber may also be used as needed.

### Pixel Circuit

The light emitting device can include a pixel circuit connected to the light emitting element. The pixel circuit may be an active matrix circuit that individually controls light emission of the first and second light emitting elements. The active matrix circuit may be a voltage or current programing circuit. A driving circuit includes a pixel circuit for each pixel. The pixel circuit can include a light emitting element, a transistor for controlling light emission luminance of the light emitting element, a transistor for controlling a light emission timing, a capacitor for holding the gate voltage of the transistor for controlling the light emission luminance, and a transistor for connection to GND without intervention of the light emitting element.

The light emitting device includes a display region and a peripheral region arranged around the display region. The light emitting device includes the pixel circuit in the display region and a display control circuit in the peripheral region. The mobility of the transistor forming the pixel circuit may be smaller than that of a transistor forming the display control circuit.

The slope of the current-voltage characteristic of the transistor forming the pixel circuit may be smaller than that of the current-voltage characteristic of the transistor forming the display control circuit. The slope of the current-voltage characteristic can be measured by a so-called Vg-Ig characteristic.

The transistor forming the pixel circuit is a transistor connected to the light emitting element such as the first light emitting element.

### Pixel

The organic light emitting device includes a plurality of pixels. Each pixel includes sub-pixels that emit mutually different colors. The sub-pixels may include, for example, R, G, and B emission colors, respectively.

In each pixel, a region also called a pixel opening emits light. The pixel opening can have a size of 5 μm (inclusive) to 15 μm (inclusive). More specifically, the pixel opening can have a size of 11 μm, 9.5 μm, 7.4 μm, 6.4 μm, or the like.

A distance between the sub-pixels can be 10 μm or less, and can be, more specifically, 8 μm, 7.4 μm, or 6.4 μm.

The pixels can have a known arrangement form in a plan view. For example, the pixels may have a stripe arrangement, a delta arrangement, a pentile arrangement, or a Bayer arrangement. The shape of each sub-pixel in a plan view may be any known shape. For example, a quadrangle such as a rectangle or a rhombus, a hexagon, or the like may be possible. A shape which is not exactly but is close to a rectangle is included in a rectangle, as a matter of course. The shape of the sub-pixel and the pixel arrangement can be used in combination.

### Application of Organic Light Emitting Element of Embodiment of Present Disclosure

The organic light emitting element according to an embodiment of the present disclosure can be used as a constituent member of a display device or an illumination device. In addition, the organic light emitting element is applicable to the exposure light source of an electrophotographic image forming device, the backlight of a liquid crystal display device, a light emitting device including a color filter in a white light source, and the like.

The display device may be an image information processing device that includes an image input unit for inputting image information from an area CCD, a linear CCD, a memory card, or the like, and an information processing unit for processing the input information, and displays the input image on a display unit.

In addition, a display unit included in an image capturing device or an inkjet printer can have a touch panel function. The driving type of the touch panel function may be an infrared type, a capacitance type, a resistive film type, or an electromagnetic induction type, and is not particularly limited. The display device may be used for the display unit of a multifunction printer.

More details will be described next with reference to the accompanying drawings. FIG. 10A shows an example of the pixel which is the component of the pixel array 110 described above. The pixel includes sub-pixels 810 (pixels 101). The sub-pixels are divided into sub-pixels 810R, 810G, and 810B by emitted light components. The light emission colors may be discriminated by the wavelengths of light components emitted from the light emitting layers, or light emitted from each sub-pixel may be selectively transmitted or undergo color conversion by a color filter or the like. Each sub-pixel includes a reflective electrode 802 as the first electrode on an interlayer insulating layer 801, an insulating layer 803 covering the end of the reflective electrode 802, an organic compound layer 804 covering the first electrode and the insulating layer, a transparent electrode 805 as the second electrode, a protection layer 806, and a color filter 807.

The interlayer insulating layer 801 can include a transistor and a capacitive element arranged in the interlayer insulating layer 801 or a layer below it. The transistor and the first electrode can electrically be connected via a contact hole (not shown) or the like.

The insulating layer 803 can also be called a bank or a pixel isolation film. The insulating layer 803 covers the end of the first electrode, and is arranged to surround the first electrode. A portion of the first electrode where no insulating layer 803 is arranged is in contact with the organic compound layer 804 to form a light emitting region.

The organic compound layer 804 includes a hole injection layer 841, a hole transport layer 842, a first light emitting layer 843, a second light emitting layer 844, and an electron transport layer 845.

The second electrode may be a transparent electrode, a reflective electrode, or a semi-transmissive electrode.

The protection layer 806 suppresses permeation of water into the organic compound layer. The protection layer is shown as a single layer but may include a plurality of layers. Each layer can be an inorganic compound layer or an organic compound layer.

The color filter 807 is divided into color filters 807R, 807G, and 807B by colors. The color filters can be formed on a planarizing film (not shown). A resin protection layer (not shown) may be arranged on the color filters. The color filters can be formed on the protection layer 806. Alternatively, the color filters can be provided on the counter substrate such as a glass substrate, and then the substrate may be bonded.

A display device 800 (corresponding to the above-described light emitting device 100) shown in FIG. 10B is provided with an organic light emitting element 826 and a TFT 818 as an example of a transistor. A substrate 811 of glass, silicon, or the like is provided and an insulating layer 812 is provided on the substrate 811. The active element such as the TFT 818 is arranged on the insulating layer, and a gate electrode 813, a gate insulating film 814, and a semiconductor layer 815 of the active element are arranged. The TFT 818 further includes the semiconductor layer 815, a drain electrode 816, and a source electrode 817. An insulating film 819 is provided on the TFT 818. The source electrode 817 and an anode 821 forming the organic light emitting element 826 are connected via a contact hole 820 formed in the insulating film.

A method of electrically connecting the electrodes (anode and cathode) included in the organic light emitting element 826 and the electrodes (source electrode and drain electrode) included in the TFT is not limited to that shown in FIG. 10B. That is, one of the anode and cathode and one of the source electrode and drain electrode of the TFT are electrically connected. The TFT indicates a thin-film transistor.

In the display device 800 shown in FIG. 10B, an organic compound layer is illustrated as one layer. However, an organic compound layer 822 may include a plurality of layers. A first protection layer 824 and a second protection layer 825 are provided on a cathode 823 to suppress deterioration of the organic light emitting element.

A transistor is used as a switching element in the display device 800 shown in FIG. 10B but may be used as another switching element.

The transistor used in the display device 800 shown in FIG. 10B is not limited to a transistor using a single-crystal silicon wafer, and may be a thin-film transistor including an active layer on an insulating surface of a substrate. Examples of the active layer include single-crystal silicon, amorphous silicon, non-single-crystal silicon such as microcrystalline silicon, and a non-single-crystal oxide semiconductor such as indium zinc oxide and indium gallium zinc oxide. Note that a thin-film transistor is also called a TFT element.

The transistor included in the display device 800 shown in FIG. 10B may be formed in the substrate such as a silicon substrate. Forming the transistor in the substrate means forming the transistor by processing the substrate such as a silicon substrate. That is, when the transistor is included in the substrate, it can be considered that the substrate and the transistor are formed integrally.

The light emission luminance of the organic light emitting element according to this embodiment can be controlled by the TFT which is an example of a switching element, and the plurality of organic light emitting elements can be provided in a plane to display an image with the light emission luminances of the respective elements. Here, the switching element according to this embodiment is not limited to the TFT, and may be a transistor formed from low-temperature polysilicon or an active matrix driver formed on the substrate such as a silicon substrate. The term “on the substrate” may mean “in the substrate”. Whether to provide a transistor in the substrate or use a TFT is selected based on the size of the display unit. For example, if the size is about 0.5 inch, the organic light emitting element may be provided on the silicon substrate.

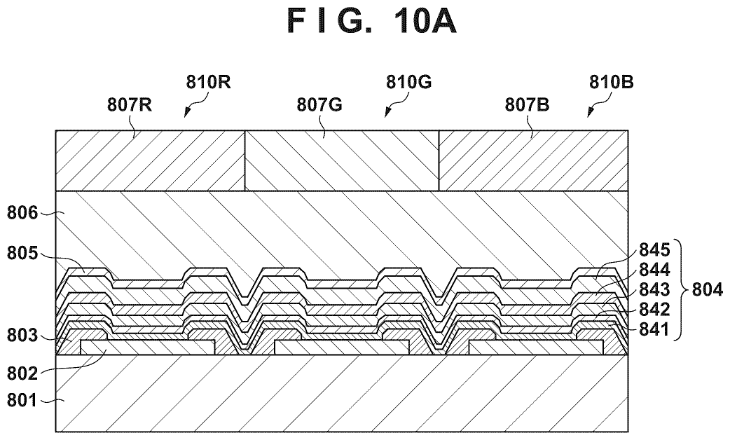

FIGS. 11A to 11C are schematic views showing an example of an image forming device using the light emitting device 100 according to this embodiment. An image forming device 926 shown in FIG. 11A includes a photosensitive member 927, an exposure light source 928, a developing unit 931, a charging unit 930, a transfer device 932, a conveyance unit 933 (a conveyance roller in the arrangement shown in FIG. 11A), and a fixing device 935.

Light 929 is emitted from the exposure light source 928, and an electrostatic latent image is formed on the surface of the photosensitive member 927. The light emitting device 100 can be applied to the exposure light source 928. The developing unit 931 can function as a developing device that includes a toner or the like as a developing agent and applies the developing agent to the exposed photosensitive member 927. The charging unit 930 charges the photosensitive member 927. The transfer device 932 transfers the developed image to a print medium 934. The conveyance unit 933 conveys the print medium 934. The print medium 934 can be, for example, paper, a film, or the like. The fixing device 935 fixes the image formed on the print medium.

Each of FIGS. 11B and 11C is a schematic view showing a form in which a plurality of light emitting units 936 are arranged in the exposure light source 928 along the longitudinal direction of a long substrate. The light emitting device 100 can be applied to each of the light emitting units 936. That is, a plurality of the pixels 101 arranged in the pixel array 110 are arranged along the longitudinal direction of the substrate. A direction 937 is a direction parallel to the axis of the photosensitive member 927. This column direction matches the direction of the axis upon rotating the photosensitive member 927. This direction 937 can also be referred to as the long-axis direction of the photosensitive member 927.

FIG. 11B shows a form in which the light emitting units 936 are arranged along the long-axis direction of the photosensitive member 927. FIG. 11C shows a form, which is a modification of the arrangement of the light emitting units 936 shown in FIG. 11B, in which the light emitting units 936 are arranged in the column direction alternately between the first column and the second column. The light emitting units 936 are arranged at different positions in the row direction between the first column and the second column. In the first column, the plurality of light emitting units 936 are arranged apart from each other. In the second column, the light emitting unit 936 is arranged at the position corresponding to the space between the light emitting units 936 in the first column. Furthermore, in the row direction, the plurality of light emitting units 936 are arranged apart from each other. The arrangement of the light emitting units 936 shown in FIG. 11C can be referred to as, for example, an arrangement in a grid pattern, an arrangement in a staggered pattern, or an arrangement in a checkered pattern.

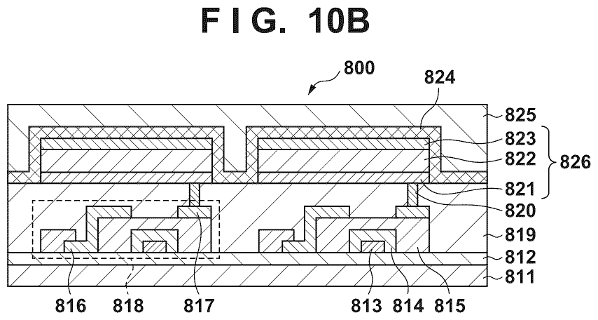

FIG. 12 is a schematic view showing an example of the display device using the light emitting device 100 according to this embodiment. A display device 1000 can include a touch panel 1003, a display panel 1005, a frame 1006, a circuit board 1007, and a battery 1008 between an upper cover 1001 and a lower cover 1009. Flexible printed circuits (FPCs) 1002 and 1004 are respectively connected to the touch panel 1003 and the display panel 1005. Active elements such as transistors are arranged on the circuit board 1007. The battery 1008 is unnecessary if the display device 1000 is not a portable apparatus. Even when the display device 1000 is a portable apparatus, the battery 1008 need not be provided at this position. The light emitting device 100 can be applied to the display panel 1005. The pixels 101 arranged in the pixel array 110 of the light emitting device 100 functioning as the display panel 1005 operate in a state in which they are connected to the active elements such as transistors arranged on the circuit board 1007.

The display device 1000 shown in FIG. 12 can be used for a display unit of a photoelectric conversion device (also referred to as an image capturing device) including an optical unit having a plurality of lenses, and an image sensor for receiving light having passed through the optical unit and photoelectrically converting the light into an electric signal. The photoelectric conversion device can include a display unit for displaying information acquired by the image sensor. In addition, the display unit can be either a display unit exposed outside the photoelectric conversion device, or a display unit arranged in the finder. The photoelectric conversion device can be a digital camera or a digital video camera.

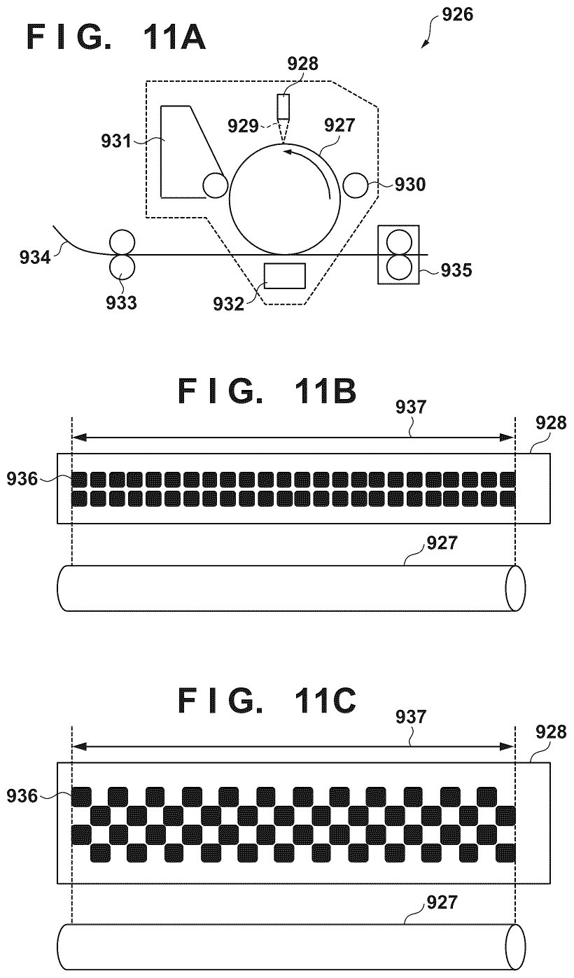

FIG. 13 is a schematic view showing an example of the photoelectric conversion device using the light emitting device 100 according to this embodiment. A photoelectric conversion device 1100 can include a viewfinder 1101, a rear display 1102, an operation unit 1103, and a housing 1104. The photoelectric conversion device 1100 can also be called an image capturing device. The light emitting device 100 according to this embodiment can be applied to the viewfinder 1101 or the rear display 1102 as a display unit. In this case, the pixel array 110 of the light emitting device 100 can display not only an image to be captured but also environment information, image capturing instructions, and the like. Examples of the environment information are the intensity and direction of external light, the moving velocity of an object, and the possibility that an object is covered with an obstacle.

The timing suitable for image capturing is a very short time in many cases, it is better to display the information as soon as possible. Therefore, the light emitting device 100 in which the pixel 101 including the light emitting element using the organic light emitting material such as an organic EL element is arranged in the pixel array 110 may be used for the viewfinder 1101 or the rear display 1102. This is so because the organic light emitting material has a high response speed. The light emitting device 100 using the organic light emitting material can be used for the devices that require a high display speed more suitably than for the liquid crystal display device.

The photoelectric conversion device 1100 includes an optical unit (not shown). This optical unit has a plurality of lenses, and forms an image on a photoelectric conversion element (not shown) that receives light having passed through the optical unit and is accommodated in the housing 1104. The focal points of the plurality of lenses can be adjusted by adjusting the relative positions. This operation can also automatically be performed.

The light emitting device 100 may be applied to a display unit of an electronic apparatus. At this time, the display unit can have both a display function and an operation function. Examples of the portable terminal are a portable phone such as a smartphone, a tablet, and a head mounted display.

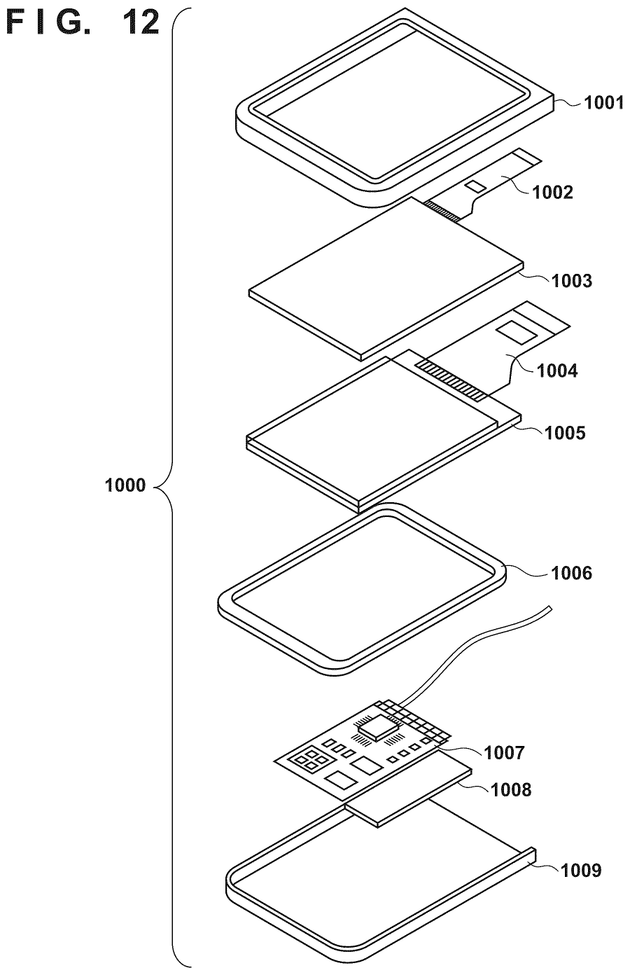

FIG. 14 is a schematic view showing an example of an electronic apparatus using the light emitting device 100 according to this embodiment. An electronic apparatus 1200 includes a display unit 1201, an operation unit 1202, and a housing 1203. The housing 1203 can accommodate a circuit, a printed board having this circuit, a battery, and a communication unit. The operation unit 1202 can be a button or a touch-panel-type reaction unit. The operation unit 1202 can also be a biometric authentication unit that performs unlocking or the like by authenticating the fingerprint. The portable apparatus including the communication unit can also be regarded as a communication apparatus. The light emitting device 100 according to this embodiment can be applied to the display unit 1201.

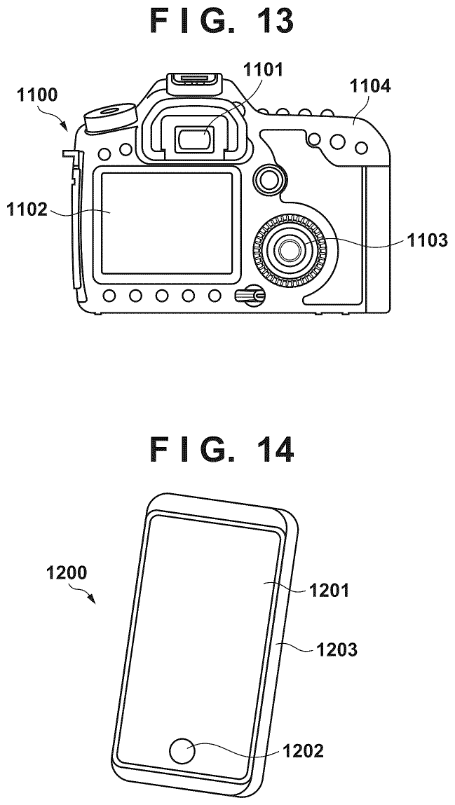

FIGS. 15A and 15B are schematic views showing examples of the display device using the light emitting device 100 according to this embodiment. FIG. 15A shows a display device such as a television monitor or a PC monitor. A display device 1300 includes a frame 1301 and a display unit 1302. The light emitting device 100 according to this embodiment can be applied to the display unit 1302. The display device 1300 can include a base 1303 that supports the frame 1301 and the display unit 1302. The base 1303 is not limited to the form shown in FIG. 15A. For example, the lower side of the frame 1301 may also function as the base 1303. In addition, the frame 1301 and the display unit 1302 can be bent. The radius of curvature in this case can be 5,000 mm (inclusive) to 6,000 mm (inclusive).

FIG. 15B is a schematic view showing another example of the display device using the light emitting device 100 according to this embodiment. A display device 1310 shown in FIG. 15B can be folded, and is a so-called foldable display device. The display device 1310 includes a first display unit 1311, a second display unit 1312, a housing 1313, and a bending point 1314. The light emitting device 100 according to this embodiment can be applied to each of the first display unit 1311 and the second display unit 1312. The first display unit 1311 and the second display unit 1312 can also be one seamless display device. The first display unit 1311 and the second display unit 1312 can be divided by the bending point. The first display unit 1311 and the second display unit 1312 can display different images, and can also display a single image together.

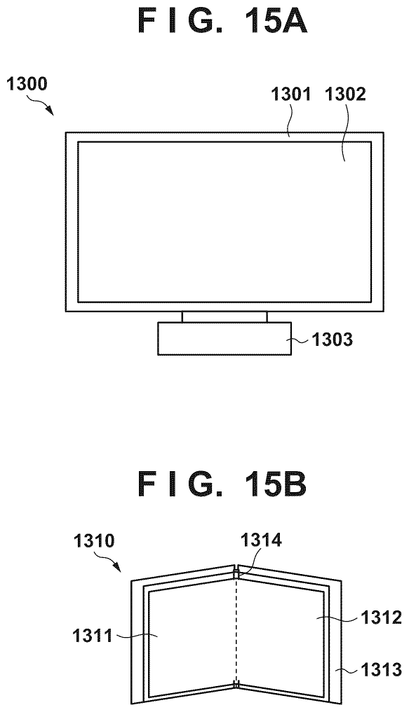

FIG. 16 is a schematic view showing an example of the illumination device using the light emitting device 100 according to this embodiment. An illumination device 1400 can include a housing 1401, a light source 1402, a circuit board 1403, an optical film 1404, and a light diffusing unit 1405. The light emitting device 100 according to this embodiment can be applied to the light source 1402. The optical film 1404 can be a filter that improves the color rendering of the light source. When performing lighting-up or the like, the light diffusing unit 1405 can throw the light of the light source over a broad range by effectively diffusing the light. The illumination device can also include a cover on the outermost portion, as needed. The illumination device 1400 can include both or one of the optical film 1404 and the light diffusing unit 1405.

The illumination device 1400 is, for example, a device for illuminating the interior of the room. The illumination device 1400 can emit white light, natural white light, or light of any color from blue to red. The illumination device 1400 can also include a light control circuit for controlling these light components. The illumination device 1400 can also include a power supply circuit connected to the light emitting device 100 functioning as the light source 1402. The power supply circuit is a circuit for converting an AC voltage into a DC voltage. White has a color temperature of 4,200 K, and natural white has a color temperature of 5,000 K. The illumination device 1400 may also include a color filter. In addition, the illumination device 1400 can include a heat radiation unit. The heat radiation unit radiates the internal heat of the device to the outside of the device, and examples are a metal having a high specific heat and liquid silicon.

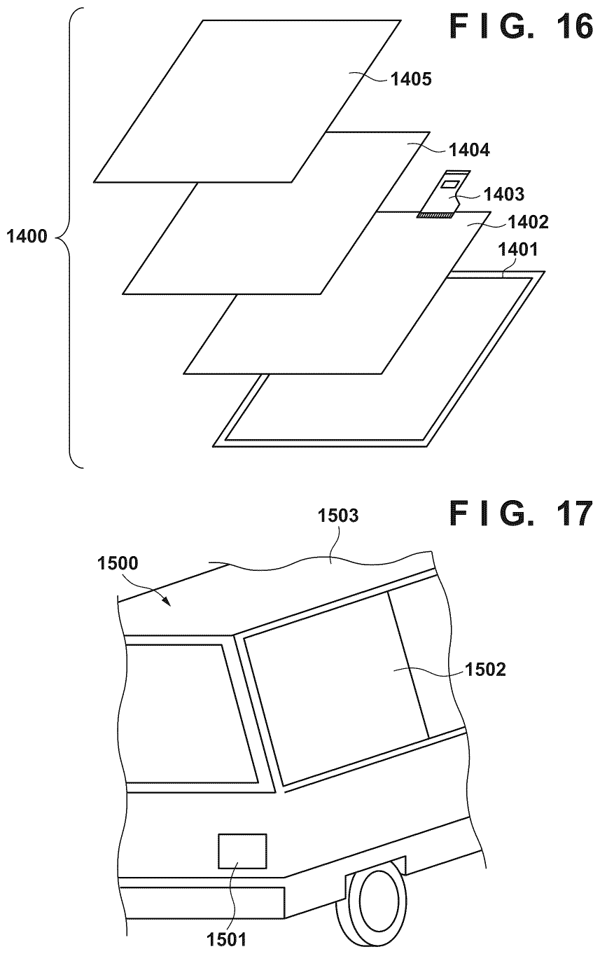

FIG. 17 is a schematic view of an automobile having a taillight as an example of a vehicle lighting appliance using the light emitting device 100 according to this embodiment. An automobile 1500 has a taillight 1501, and can have a form in which the taillight 1501 is turned on when performing a braking operation or the like. The light emitting device 100 according to this embodiment can be used as a headlight serving as a vehicle lighting appliance. The automobile is an example of a moving body, and the moving body may be a ship, a drone, an aircraft, a railroad car, an industrial robot, or the like. The moving body may include a main body and a lighting appliance provided in the main body. The lighting appliance may be used to make a notification of the current position of the main body.

The light emitting device 100 according to this embodiment can be applied to the taillight 1501. The taillight 1501 can include a protection member for protecting the light emitting device 100 functioning as the taillight 1501. The material of the protection member is not limited as long as the material is a transparent material with a strength that is high to some extent, and an example is polycarbonate. The protection member may be made of a material obtained by mixing a furandicarboxylic acid derivative, an acrylonitrile derivative, or the like in polycarbonate.

The automobile 1500 can include a vehicle body 1503, and a window 1502 attached to the vehicle body 1503. This window can be a window for checking the front and back of the automobile, and can also be a transparent display such as a head-up display. For this transparent display, the light emitting device 100 according to this embodiment may be used. In this case, the constituent materials of the electrodes and the like of the light emitting device 100 are formed by transparent members.

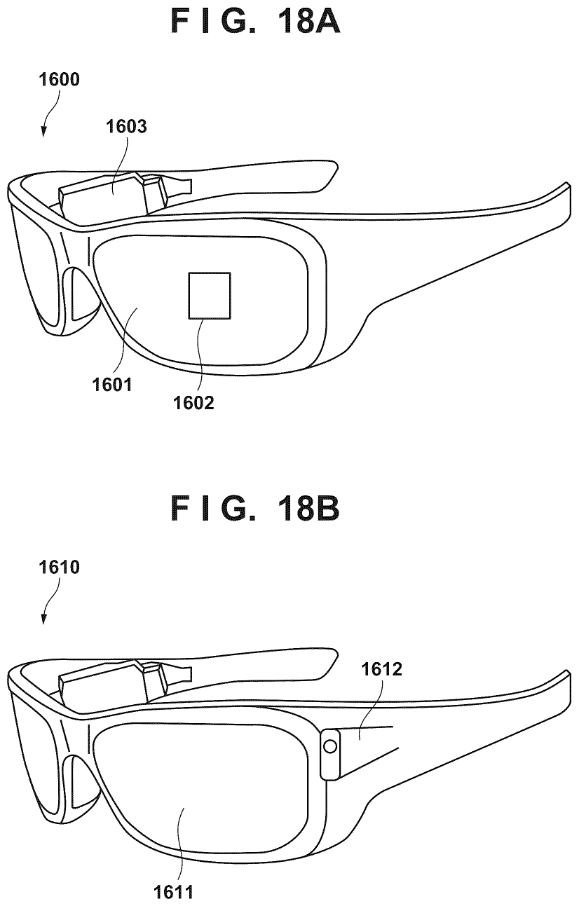

Further application examples of the light emitting device 100 according to this embodiment will be described with reference to FIGS. 18A and 18B. The light emitting device 100 can be applied to a system that can be worn as a wearable device such as smartglasses, a Head Mounted Display (HMD), or a smart contact lens. An image capturing display device used for such application examples includes an image capturing device capable of photoelectrically converting visible light and a light emitting device capable of emitting visible light.

Glasses 1600 (smartglasses) according to one application example will be described with reference to FIG. 18A. An image capturing device 1602 such as a CMOS sensor or an SPAD is provided on the surface side of a lens 1601 of the glasses 1600. In addition, the light emitting device 100 according to this embodiment is provided on the back surface side of the lens 1601.

The glasses 1600 further include a control device 1603. The control device 1603 functions as a power supply that supplies electric power to the image capturing device 1602 and the light emitting device 100 according to each embodiment. In addition, the control device 1603 controls the operations of the image capturing device 1602 and the light emitting device 100. An optical system configured to condense light to the image capturing device 1602 is formed on the lens 1601.

Glasses 1610 (smartglasses) according to one application example will be described with reference to FIG. 18B. The glasses 1610 include a control device 1612, and an image capturing device corresponding to the image capturing device 1602 and the light emitting device 100 are mounted on the control device 1612. The image capturing device in the control device 1612 and an optical system configured to project light emitted from the light emitting device 100 are formed in a lens 1611, and an image is projected to the lens 1611. The control device 1612 functions as a power supply that supplies electric power to the image capturing device and the light emitting device 100, and controls the operations of the image capturing device and the light emitting device 100. The control device 1612 may include a line-of-sight detection unit that detects the line of sight of a wearer. The detection of a line of sight may be done using infrared rays. An infrared ray emitting unit emits infrared rays to an eyeball of the user who is gazing at a displayed image. An image capturing unit including a light receiving element detects reflected light of the emitted infrared rays from the eyeball, thereby obtaining a captured image of the eyeball. A reduction unit for reducing light from the infrared ray emitting unit to the display unit in a planar view is provided, thereby reducing deterioration of image quality.

The line of sight of the user to the displayed image is detected from the captured image of the eyeball obtained by capturing the infrared rays. An arbitrary known method can be applied to the line-of-sight detection using the captured image of the eyeball. As an example, a line-of-sight detection method based on a Purkinje image obtained by reflection of irradiation light by a cornea can be used.

More specifically, line-of-sight detection processing based on pupil center corneal reflection is performed. Using pupil center corneal reflection, a line-of-sight vector representing the direction (rotation angle) of the eyeball is calculated based on the image of the pupil and the Purkinje image included in the captured image of the eyeball, thereby detecting the line-of-sight of the user.

The light emitting device 100 according to the embodiment of the present disclosure can include an image capturing device including a light receiving element, and control a displayed image based on the line-of-sight information of the user from the image capturing device.

More specifically, the light emitting device 100 decides a first visual field region at which the user is gazing and a second visual field region other than the first visual field region based on the line-of-sight information. The first visual field region and the second visual field region may be decided by the control device of the light emitting device 100, or those decided by an external control device may be received. In the display region of the light emitting device 100, the display resolution of the first visual field region may be controlled to be higher than the display resolution of the second visual field region. That is, the resolution of the second visual field region may be lower than that of the first visual field region.

In addition, the display region includes a first display region and a second display region different from the first display region, and a region of higher priority is decided from the first display region and the second display region based on line-of-sight information. The first display region and the second display region may be decided by the control device of the light emitting device 100, or those decided by an external control device may be received. The resolution of the region of higher priority may be controlled to be higher than the resolution of the region other than the region of higher priority. That is, the resolution of the region of relatively low priority may be low.

Note that AI may be used to decide the first visual field region or the region of higher priority. The AI may be a model configured to estimate the angle of the line of sight and the distance to a target ahead the line of sight from the image of the eyeball using the image of the eyeball and the direction of actual viewing of the eyeball in the image as supervised data. The AI program may be held by the light emitting device 100, the image capturing device, or an external device. If the external device holds the AI program, it is transmitted to the light emitting device 100 via communication.

When performing display control based on line-of-sight detection, smartglasses further including an image capturing device configured to capture the outside can be applied. The smartglasses can display captured outside information in real time.

According to the present disclosure, a technique advantageous in improving display quality can be provided.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

1. A light emitting device comprising:
a pixel array including a plurality of pixels arranged so as to form a plurality of rows;
a write control circuit configured to supply a write control signal to a selected row in order to write an image signal in a pixel arranged in a selected row among the plurality of rows; and
a light emission control circuit configured to supply a light emission control signal to a selected row among the plurality of rows, wherein:
the plurality of rows includes a row including a holding circuit and a gate circuit,
the holding circuit memorizes that the write control signal is supplied to the row including the holding circuit and the gate circuit, and
in a case where the light emission control signal is supplied to the gate circuit and the holding circuit memorizes that the write control signal is supplied, the gate circuit outputs the light emission control signal to a pixel arranged in a row including the holding circuit and the gate circuit.

2. The light emitting device according to claim 1, wherein
in each frame, the pixel array includes a display region formed by a row where pixels in a light emission state are arranged among the plurality of rows, and a non-display region formed by a row where pixels are in a non-light emission state among the plurality of rows, and
positions of the display region and the non-display region are changed at a predetermined timing.

3. The light emitting device according to claim 2, wherein the write control circuit is configured to supply the write control signal to a row forming the display region among the plurality of rows.

4. The light emitting device according to claim 2, wherein the write control circuit is configured not to supply the write control signal to a row forming the non-display region among the plurality of rows.

5. The light emitting device according to claim 2, wherein, in each frame, the light emission control circuit is configured to supply the light emission control signal to a row forming the display region among the plurality of rows over a predetermined period corresponding to each row.

6. The light emitting device according to claim 2, wherein the holding circuit and the gate circuit are arranged in each row of the plurality of rows.

7. The light emitting device according to claim 2, wherein
the plurality of rows include a first row which is always included in the display region, and a second row which is changed between the display region and the non-display region, and
the holding circuit and the gate circuit are arranged in the second row.

8. The light emitting device according to claim 7, wherein the holding circuit and the gate circuit are not arranged in the first row.

9. The light emitting device according to claim 6, wherein, in each frame from a second frame, before the write control circuit starts to supply the write control signal, a memory of the holding circuit in a row forming the non-display region among the plurality of rows in an immediately preceding frame is reset.

10. The light emitting device according to claim 6, wherein, in a row forming the display region among the plurality of rows, a memory of the holding circuit is reset when supply of the light emission control signal ends.

11. The light emitting device according to claim 1, wherein a memory of the holding circuit is reset before a first frame starts.

12. A display device comprising:
the light emitting device according to claim 1; and
an active element connected to the light emitting device.

13. A photoelectric conversion device comprising:
an optical unit including a plurality of lenses;
an image sensor configured to receive light having passed through the optical unit; and
a display configured to display an image,
wherein the display displays an image captured by the image sensor, and includes the light emitting device according to claim 1.

14. An electronic apparatus comprising:
a housing provided with a display; and
a communication unit provided in the housing and configured to perform external communication,
wherein the display includes the light emitting device according to claim 1.

15. An illumination device comprising:
a light source; and
at least one of a light diffusing unit and an optical film, wherein the light source includes the light emitting device according to claim 1.

16. A moving body comprising:
a main body; and
a lighting appliance provided in the main body,
wherein the lighting appliance includes the light emitting device according to claim 1.
